(19) United States
(12) Patent Application Publication
(10) Pub. No.: US 2020/0380971 A1
(43) Pub. Date: Dec. 3, 2020

(54) METHOD OF ACTIVATING VOICE ASSISTANT AND ELECTRONIC DEVICE WITH VOICE ASSISTANT

(71) Applicants: Inventec (Pudong) Technology Corporation, Shanghai (CN); INVENTEC CORPORATION, Taipei (TW)

(72) Inventors: Chun-Chi LIN, Taipei (TW); Ying-Shan CHEN, Taipei (TW); Tong-Ting WEI, Taipei (TW)

(21) Appl. No.: 16/540,237

(22) Filed: Aug. 14, 2019

(30) Foreign Application Priority Data
May 29, 2019 (CN) 201910457867.2

(51) Int. Cl. G10L 15/22; G10L 15/02; G10L 15/08

(52) U.S. Cl. CPC G10L 15/22; G10L 15/02; G10L 15/083; G10L 2015/088; G10L 2015/223; G10L 2015/227; G10L 2015/221

(57) ABSTRACT

A method of starting voice assistant is adapted to an electronic device. The method comprises providing electric power to a wake-up assembly of the electronic device, wherein the electronic device is in a sleep state, obtaining an wake-up signal by the wake-up assembly and performing an wake-up procedure, providing the power to a processor of the electronic device and a communication module of the electronic device to wake up the electronic device from the sleep state after the wake-up signal passing the wake-up procedure, and performing a voice assistant procedure by the processor and the communicatively connecting to a voice assistant server by the communication module.

### CROSS-REFERENCE TO RELATED APPLICATIONS

This non-provisional application claims priority under 35 U.S.C. § 119(a) on Patent Application No(s). 201910457867.2 filed in China on May 29, 2019, the entire contents of which are hereby incorporated by reference.

### BACKGROUND

### 1. Technical Field

The present disclosure provides a method of activating voice assistant and an electronic device with a voice assistant, and more particularly to the electronic device capable of activating the voice assistant when the electronic device in a sleep mode and a method thereof.

### 2. Related Art

With the maturity of speech recognition technology, users can use digital voice assistant (DVA) installed on their smartphones or interact with digital voice assistants on their personal computers. On the other hand, because of the portability of the laptop, users would like to use the laptops with the voice assistant installed inside for a long time. In order to save battery power consumption, users may put the laptop into the sleep mode by closing the top cover.

However, regarding the current laptop on the market, users can use the digital voice assistant only when the laptop is in an operating state, and users cannot use the digital voice assistant when the top cover is closed or after the user presses the power button to put the laptop into a sleep state. The conditions described above bring a lot of inconvenience to the user.

### SUMMARY

According to one or more embodiment of this disclosure, a method of activating a voice assistant adapted to an electronic device comprising: providing electric power to a wake-up assembly of the electronic device, wherein the electronic device is in a sleep state; obtaining a wake-up signal by the wake-up assembly and performing a wake-up procedure; providing the power to a processor of the electronic device and a communication module of the electronic device to wake up the electronic device from the sleep state after the wake-up signal passes the wake-up procedure; and performing a voice assistant procedure by the processor and the communicatively connecting to a voice assistant server by the communication module.

According to one or more embodiment of this disclosure, an electronic device with a voice assistant comprising: a power supply supplies electric power; a wake-up assembly electrically connecting to the power supply to receive the power, wherein the wake-up assembly is configured to obtain a wake-up signal, and the wake-up assembly performs a wake-up procedure and generates a wake-up result according to the wake-up signal; a processor electrically connecting to the power supply and the wake-up assembly, wherein the processor operating is in a sleep state or in an operating state, the processor selectively switches from the sleep state to the operating state according to the wake-up result, and the processor performs a voice assistant procedure during the operating state; and a communication module electrically connected to the processor, wherein the communication module communicably connects to a voice assistant server when the processor performs the voice assistant procedure; wherein the processor enters the operating state when the power supply inputs the power to the processor and the processor enters the sleep state when the power supply stops the power to the processor.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a block diagram of an electronic device with a voice assistant according to an embodiment of the present disclosure;

FIG. 1B illustrates a perspective view of an electronic device with a voice assistant according to an embodiment of the present disclosure;

FIG. 1C is a block diagram of the wake-up assembly according to another embodiment of the present disclosure;

FIG. 2 is a flow chart of a method of activating a voice assistant according to an embodiment of the present disclosure; and

FIG. 3 is a detail flow chart of steps S33˜S35 according to another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

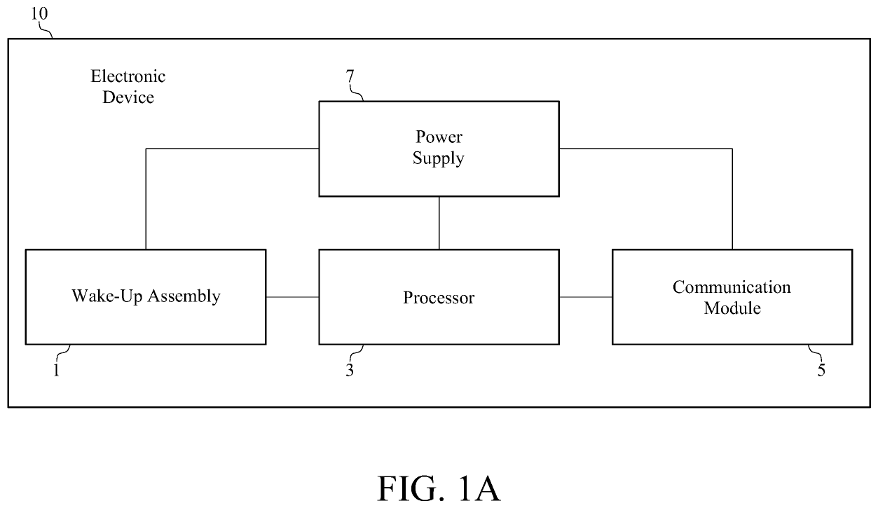

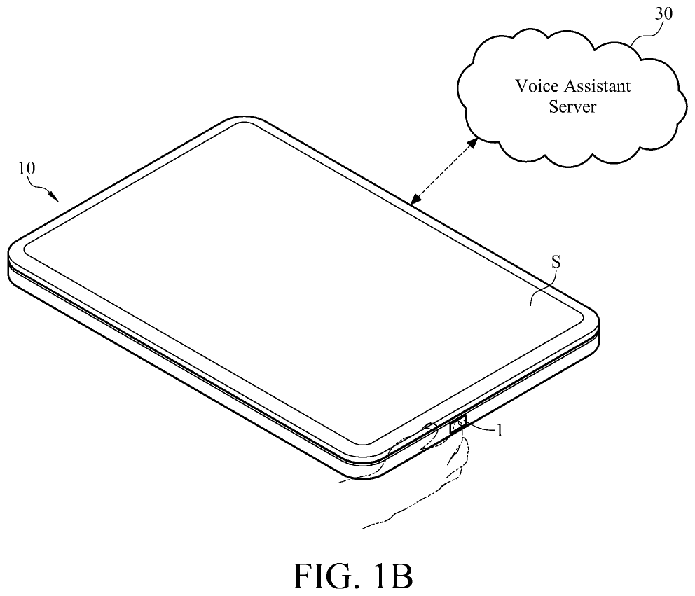

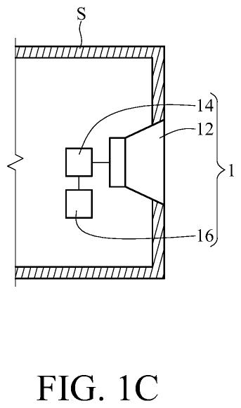

Please refer to FIG. 1A and FIG. 1B. FIG. 1A illustrates a block diagram of an electronic device 10 with a voice assistant according to an embodiment of the present disclosure, and FIG. 1B illustrates a perspective view of an electronic device 10 with a voice assistant according to an embodiment of the present disclosure. As shown in FIG. 1A, the electronic device 10 with a voice assistant comprises a wake-up assembly 1, a processor 3, a communication module 5 and a power supply 7. The power supply 7 electrically connects to the wake-up assembly 1, the processor 3, and the communication module 5. The processor 3 electrically connects to the wake-up assembly 1 and the communication module 5. Practically, the electronic device 10 is, for example, a laptop. However, the present disclosure does not limit the implementation of the electronic device 10.

The wake-up assembly 1 electrically connects to the power supply 7 for receiving the power provided by the power supply 7. The wake-up assembly 1 is configured to obtain a wake-up signal, perform a wake-up procedure to generate a wake-up result.

In an embodiment, the wake-up signal is a voice signal, for example, “Hi Cortana”, and the wake-up assembly 1 is a voice recognition circuit. The wake-up procedure comprises the following steps: the voice recognition circuit compares a voice signal and a stored wake-up signal once the voice recognition circuit detects the voice signal, and if they match, that is, the similarity degree between the voice signal and the stored wake-up signal is greater than or equal to a default value, the voice recognition circuit generates a wake-up result indicating that a wake-up operation is allowable, which means that the wake-up signal passes the wake-up procedure. Otherwise, the voice recognition circuit generates another wake-up result representing that the wake-up operation is prohibited, which means that the wake-up signal does not pass the wake-up procedure.

In another embodiment, the wake-up assembly 1 is, for example, an identification assembly, the wake-up signal is an identity verification signal, and the wake-up procedure is an identity verification procedure. In this embodiment, the wake-up result is used to indicate whether a user whose identity is verified by the identification assembly is legal or not. Further, the embodiment of the identification assembly is adopted in the following paragraphs.

Please refer to FIG. 1B, the appearance schematic diagram of the electronic device 10. In an embodiment, the electronic device 10 with voice assistant comprises a shell S with an outer surface. For example, when the electronic device 10 is a laptop illustrated in FIG. 1B, the shell S is the casing of the laptop. In the embodiment of the appearance diagram illustrated in FIG. 1B, the identification assembly is a fingerprint recognition assembly, wherein the fingerprint recognition assembly partially exposes from the outer surface of the shell S, and the exposed part is configured to receive a user's fingerprint.

Please refer to FIG. 1C, which illustrates a block diagram of the wake-up assembly 1 according to another embodiment of the present disclosure. In the first example of said another embodiment, the wake-up assembly 1 comprises a directional microphone 12, an analog-to-digital converter 14, and a voice recognition circuit 16. The directional microphone 12 is configured to obtain a wake-up voice and to determine whether a loudness of the wake-up voice exceeds a specified decibel value. The analog-to-digital converter 14 electrically connects to the directional microphone 12 and is configured to convert the wake-up voice into a digital signal. The voice recognition circuit 16 electrically connects to the analog-to-digital converter 14 and is configured to determine whether the digital signal conforms to a stored signal. Specifically, in this embodiment, the user makes a voice with a certain loudness for identification and said voice includes a keyword to activate a voice assistant. Only if the wake-up assembly 1 determines that the loudness of the received wake-up voice exceeds a default value, the wake-up assembly may ensure that the wake-up voice is an intentional input by the user rather than background noises. The wake-up assembly 1 converts an analog signal of the wake-up voice into a digital signal, and then determine whether the first keyword contained in the digital signal conforms to the second keyword stored in the system according to the digital signal. Specifically, the voice recognition circuit 16 obtains a similarity degree between the first keyword and the second keyword to determine whether they are consistent with each other. If the similarity degree is greater than or equal to a default value, the voice recognition circuit 16 generated a wake-up result. This wake-up result means that the digital signal conforms to the stored digital signal and also means that the user is a legal user who sets or knows the keyword. In this embodiment, the first keyword and the second keyword are equivalent to the password implemented by voice. Because the directional microphone 12 is adopted, only when the wake-up voice made by the user is loud enough, the wake-up voice may be received by the directional microphone 12 and be converted into the digital signal by the analog-to-digital converter 14. Therefore, when the user does not enable the voice assistant by his voice, the power consumption of the analog-to-digital converter 14 and the voice recognition circuit 16 can be saved. Furthermore, the power consumption of the electronic device 10 may be further saved.

In comparison with the first example of said another embodiment, in the second example thereof, the voice recognition circuit 16 of the wake-up assembly 1 further comprises a voiceprint recognition module with a stored second voiceprint. After the wake-up assembly 1 determines that the loudness of the received wake-up voice exceeds the default value, in addition to converting the analog signal of the wake-up voice into the digital signal and determining whether the first keyword contained in the digital signal conforms to the second keyword contained in the stored digital signal in the system, the wake-up assembly further determines whether a first voiceprint (such as the waveform signal) contained in the digital signal matches the second voiceprint recorded by the legal user. If both of the first keyword and the first voiceprint respectively conform to the second keyword and the second voiceprint recorded by the legal user, the wake-up assembly 1 may ensure that this wake-up voice is indeed made by the legal user, and then continues the flow of activating the voice assistant. In the second example, since the voice recognition circuit 16 of the wake-up assembly 1 further comprises the voiceprint recognition module, it is exclusive that only a legal user can activate the voice assistant, and this avoids the possibility that someone who eavesdrops the keyword beforehand easily activates the voice assistant of the electronic device 10 and thus invades the personal privacy of the legal user.

The processor 3 has a sleep state and an operating state. The sleep state is, for example, the S3 state defined in ACPI (Advanced Configuration and Power Interface). The power supply 7 does not provide the power to the processor 3 when the processor 3 is in the sleep state. The operating state is, for example, the S0 state defined in ACPI. The power supply 7 provides the power to the processor 3 for its operations when the processor is in the operating state. The processor 3 is configured to selectively switch from the sleep state to the operating state according to the wake-up result. In other words, after the user provides a legal wake-up signal to pass the general wake-up procedure or the specific wake-up procedure with an identification, the processor 3 in the sleep state may be waked up and the power supply 7 provides the power to the processor 3 so that the processor 3 may enter into the operating state. After switching to the operating state, the processor 3 may perform a voice assistant procedure. The communication module 5 is configured to communicatively connect to a voice assistant server 30 when the processor 3 performs the voice assistant procedure, so the voice operating instruction generated on the electronic device 10 and the response message from the voice assistant server 30 can be transmitted.

The power supply 7 is configured to provide power to every component of the electronic device 10 for their operations, wherein said components comprise the wake-up assembly 1, the processor 3, and the communication module 5.

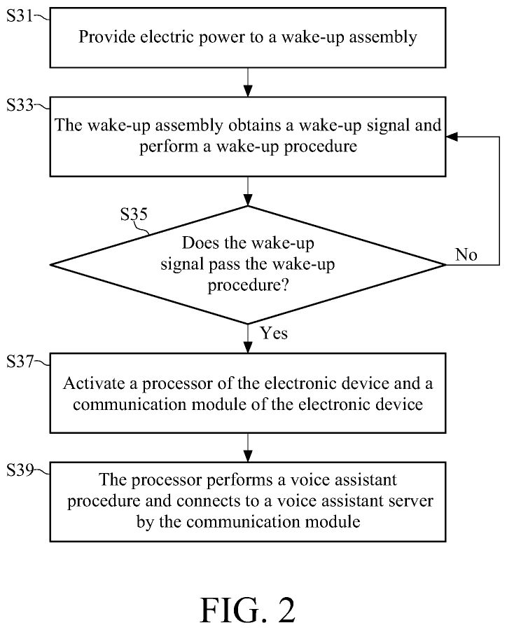

Please refer to FIG. 2, which illustrates a flow chart of a method of activating a voice assistant according to an embodiment of the present disclosure. Said method is adapted to the electronic device 10 as shown in FIG. 1A and FIG. 1B.

Please refer to step S31, “Provide electric power to a wake-up assembly 1”. Specifically, regarding an electronic device 10 in a sleep state, the power supply 7 provides the power to the wake-up assembly 1 of the electronic device 10. In an embodiment, the wake-up assembly 1 is an identification assembly. The following paragraphs take the identification assembly as an example.

Practically, before the electronic device 10 enters the sleep state, the user may determine whether to enable a function that the voice assistant can be activated during the sleep state. This function may be implemented by hardware such as a specific hardware switch disposed on the outer surface of the electronic device 10. This function may also be implemented by software. For example, using a dialogue window to ask the user whether he/she permits login to perform an identification by fingerprint verification for activating the voice assistant when the electronic device 10 is in the sleep state. If the user determines to use the fingerprint verification to log in for activating the voice assistant, the user's fingerprint may need to be collected in advance for the verification afterward. When the user enables the function that “activating a voice assistant in the sleep state”, the user may close the top cover or press the power button for the electronic device 10 to enter the S3 state (sleep state) defined by ACPI, while the power supply 7 still provides power to the identification assembly 1.

Please refer to step S33, “A wake-up assembly obtains a wake-up signal and performs a wake-up procedure”. Specifically, when the wake-up assembly adopts an identification assembly, this step is equivalent to “The identification assembly obtains an identity verification signal and performs an identity verification procedure”.

In an embodiment, said identification assembly is a fingerprint recognition assembly, and the identification signal is a fingerprint image. The identity verification is, for example, using the recognition circuit of the fingerprint recognition assembly to compare whether the received fingerprint image conforms to a stored fingerprint image, thereby determining whether the user who attempts to activate the voice assistant is a legal user or not. The identification assembly may also adopt biometric recognition techniques such as palm print, iris, retina, or vein. The present disclosure does not limit the type of the biometric recognition technique serving as identity verification.

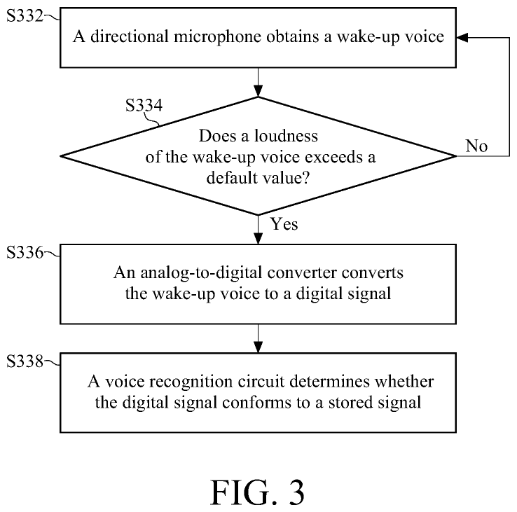

Please refer to FIG. 3, which illustrates a detail flow chart of steps S33˜S35 according to another embodiment. In said another embodiment, the wake-up assembly 1 comprises a directional microphone 12, an analog-to-digital converter 14, and a voice recognition circuit 16. Please refer to step S332: The directional microphone 12 obtains the wake-up voice. Specifically, the user faces the directional microphone 12 and makes the wake-up voice with enough volume, with the wake-up voice containing a keyword for wake up the processor 3 and the communication module 5. Please refer to step S334, “Determine whether a loudness of the wake-up voice exceeds a threshold value”. If the determination result is negative, it represents that the sound received by the directional microphone is probably background noise, rather than the wake-up voice of the user, and thus back to step S332. On the other hand, when the loudness of the wake-up voice exceeds a specified decibel value, the method moves to step S334, “The analog-to-digital converter 14 convert the wake-up voice into a digital signal”, the digital signal is served as the wake-up signal. The aforementioned steps S332˜S336 correspond to step S33 in FIG. 2. Please refer to step S338, “The voice recognition circuit 16 determines whether the digital signal conforms to a stored digital signal. In the determination is positive, it represents that the wake-up signal passes the wake-up procedure. The step S338 corresponds to step S35 in FIG. 2.

Please refer to FIG. 3. In the first example of said another embodiment, for example, the user may speak (pronounce) a wake-up keyword such as “Activate my Microsoft Cortana”. After the directional microphone assembly receives this wake-up voice and determines that the decibel value of the word “Activate” exceeds a default value, the analog-to-digital converter 14 instantly converts the voice signal “my Microsoft Cortana” into a digital signal, and then compares this digital signal with a stored digital signal to determine whether this wake-up voice is from a legal user. In the second example of said another embodiment, in step S338, in addition to determining whether the first keyword contained in the wake-up voice signal matches to the second keyword contained in the stored digital signal, the voice recognition circuit 16 further compares the first voiceprint (the waveform) of the voice signal and the second voiceprint recorded by legal user to determine whether both voiceprints are consistent. In this example, both of the keyword and the voiceprint have to pass the verification, and then the user who pronounces the wake-up voice can be considered as passing the wake-up procedure (identity verification procedure).

Please refer to step S35, “determining whether the wake-up signal passes the wake-up procedure”. In the embodiment which the identity recognition procedure is serving as the wake-up procedure, if the identity recognition fails, the remaining steps will not be performed, the voice assistant will not be activated, and the method of the present disclosure returns to step S33 to wait for another wake-up signal. If the identity recognition is passed, the method of the present disclosure continues to perform step S7.

Please refer to step S37. After the wake-up signal passes the wake-up procedure, the power is provided to the processor 3 of the electronic device 10 and the communication module 7 of the electronic device 10 to wake up the processor 3 and the communication module 7 that are in a sleep state.

Please refer to step S39, “The processor 3 performs a voice assistant procedure and connects to a voice assistant server 30 by the communication module 7”. When the voice assistant procedure is ready, the voice assistant procedure may output a greeting voice notification such as “Hi Tom, may I help you?” to inform the user that he or she may start to interact with the voice assistant.

In an embodiment, a voice receiver of the electronic device 10 may be activated at when the step S39 is performed or when the step S37 is performed, and a vocal collection gain function and a non-human noise reduction function of the voice receiver can be also enabled. Therefore, the user voice received by the voice assistant may be more clear, and the accuracy of the semantic determination by the voice assistant may be improved.

In view of the above, the embodiments of the present disclosure propose an electronic device that is capable of activating a voice assistant in a sleep state and a method of activating a voice assistant. The disclosed operational flow and the wake-up mechanism (such as user identification mechanism) enables the laptop to activate the digital voice assistant when its top cover is folded, so the operating scenario using the digital voice assistant is expanded. The user interacts with the digital voice assistant on the laptop as if it were a smart speaker. The user can use the spoken dialogue to complete the task without the participation of the screen. In addition, the user identification is confirmed by the identification assembly before the voice assistant is enabled, so the privacy of users and the data security may be confirmed. The present disclosure may avoid others to steal the user's private schedule or address book and other information through the voice assistant.

What is claimed is:

1. A method of activating a voice assistant adapted to an electronic device comprising:
providing electric power to a wake-up assembly of the electronic device, wherein the electronic device is in a sleep state;
obtaining a wake-up signal by the wake-up assembly and performing a wake-up procedure;
providing the power to a processor of the electronic device and a communication module of the electronic device to wake up the electronic device from the sleep state after the wake-up signal passes the wake-up procedure; and
performing a voice assistant procedure by the processor and the communicatively connecting to a voice assistant server by the communication module.

2. The method of activating voice assistant of claim 1, wherein the wake-up assembly is an identification assembly, the wake-up signal is an identity verification signal, and the wake-up procedure is an identity verification procedure.

3. The method of activating voice assistant of claim 2, wherein the identification assembly is a fingerprint recognition assembly, and the identity verification signal is a fingerprint image.

4. The method of activating voice assistant of claim 1, wherein the wake-up assembly is a voice recognition circuit, the wake-up signal is a voice signal, and performing the wake-up procedure by the wake-up assembly further comprises:
comparing a similarity degree between the voice signal and a stored voice signal after the voice recognition circuit obtains the voice signal; and
generating a wake-up result when the similarity degree is greater than or equal to a default value, wherein the wake-up result is configured to indicate that the wake-up signal passes the wake-up procedure.

5. The method of activating voice assistant of claim 1, wherein the wake-up assembly comprises a directional microphone, an analog-to-digital converter, and a voice recognition circuit, and the wake-up procedure further comprises:
obtaining a wake-up voice by the directional microphone;
converting the wake-up voice into a digital signal serving as the wake-up signal by the analog-to-digital converter when a loudness of the wake-up voice is greater than a threshold value; and
determining whether the digital signal conforms to a stored digital signal by the voice recognition circuit.

6. The method of activating voice assistant of claim 5, wherein determining whether the digital signal conforms to the stored digital signal by the voice recognition circuit further comprises:
obtaining a first keyword form the digital signal by the voice recognition circuit;
obtaining a second keyword from the stored digital signal by the voice recognition circuit;
obtaining a similarity degree between the first keyword and the second keyword by the voice recognition circuit; and
generating a wake-up result by the voice recognition circuit when the similarity degree is greater than or equal to a default value, wherein the wake-up result is configured to indicate that the digital signal conforms to the stored digital signal.

7. The method of activating voice assistant of claim 5, wherein determining whether the digital signal conforms to the stored digital signal by the voice recognition circuit further comprises:
obtaining a first keyword form the digital signal by the voice recognition circuit;
obtaining a first voiceprint from the digital signal by a voiceprint recognition circuit;
obtaining a second keyword from the stored digital signal by the voice recognition circuit;
obtaining a second voiceprint from the stored digital signal by the voiceprint recognition circuit;
obtaining a first similarity degree between the first keyword and the second keyword; and
obtaining a second similarity degree between the first voiceprint and the second voiceprint; wherein
generating a wake-up result when the first similarity degree is greater than or equal to a first default value and the second similarity degree is greater than or equal to a second default value, wherein the wake-up result is configured to indicate that the digital signal conforms to the stored digital signal.

8. The method of activating voice assistant of claim 1, after the wake-up signal passes the wake-up procedure, further comprising:
activating a voice receiver of the electronic device, and enabling a vocal collection enhancing function and a noise reduction function of the voice receiver.

9. An electronic device with a voice assistant comprising:
a power supply supplies electric power;
a wake-up assembly electrically connecting to the power supply to receive the power, wherein the wake-up assembly is configured to obtain a wake-up signal, and the wake-up assembly performs a wake-up procedure and generates a wake-up result according to the wake-up signal;
a processor electrically connecting to the power supply and the wake-up assembly, wherein the processor operating is in a sleep state or in an operating state, the processor selectively switches from the sleep state to the operating state according to the wake-up result, and the processor performs a voice assistant procedure during the operating state; and
a communication module electrically connected to the processor, wherein the communication module communicably connects to a voice assistant server when the processor performs the voice assistant procedure;
wherein the processor enters the operating state when the power supply inputs the power to the processor and the processor enters the sleep state when the power supply stops the power to the processor.

10. The electronic device with voice assistant of claim 9, wherein the wake-up assembly is an identification assembly, the wake-up signal is an identity verification signal, and the wake-up procedure is an identity verification procedure.

11. The electronic device with voice assistant of claim 10 further comprising a shell with an outer surface, wherein the identification assembly is a fingerprint recognition assembly, and the fingerprint recognition assembly partially exposed from the outer surface.

12. The electronic device with voice assistant of claim 9, wherein the wake-up assembly is a voice recognition circuit, the wake-up signal is a voice signal, and the voice recognition circuit obtains a similarity degree between the voice signal and a stored wake-up signal to generate the wake-up result.

13. The electronic device with voice assistant of claim 9, wherein the wake-up assembly comprises a directional microphone, an analog-to-digital converter, and a voice recognition circuit, the directional microphone is configured to obtain a wake-up voice and determines whether a loudness of the wake-up voice is greater than a threshold value; the analog-to-digital converter electrically connecting to the directional microphone converts the wake-up voice into a digital signal; and the voice recognition circuit electrically connecting to the analog-to-digital converter determines whether the digital signal conforms to the stored digital signal.

14. The electronic device with voice assistant of claim 13, wherein the voice recognition circuit further obtains a first keyword from the digital signal, obtains a second keyword from the stored digital signal, obtains a first similarity degree between the first keyword and the second keyword, and generates the wake-up result when the first similarity degree is greater than or equal to a default value, wherein the wake-up result is configured to indicate that the wake-up signal passes the wake-up procedure.

15. The electronic device with voice assistant of claim 14, wherein the voice recognition circuit further comprises a voiceprint recognition module and the voiceprint recognition module is configured to obtain a first voiceprint from the digital signal and to obtain a second voiceprint from the stored digital signal, and the voiceprint recognition module obtains a second similarity degree between the first voiceprint and the second voiceprint; and the voice recognition circuit further generates the wake-up result when the first similarity degree is greater than or equal to a first default value and the second similarity degree is greater than or equal to a second default value, and the wake-up result is further configured to indicate that the digital signal conforms to the stored digital signal.

16. The electronic device with voice assistant of claim 9, wherein the electronic device is a laptop.
